(19) United States
(12) Patent Application Publication
(10) Pub. No.: US 2019/0311833 A1
(43) Pub. Date: Oct. 10, 2019

(54) TRANSFORMER

(71) Applicant: ABB Schweiz AG, Baden (CH)

(72) Inventors: Wolfgang Moenig, Brilon (DE); Ulrich Frigger, Brilon (DE)

(21) Appl. No.: 16/342,216

(22) PCT Filed: Sep. 26, 2017
(86) PCT No.: PCT/EP2017/074375

§ 371 Date: Apr. 16, 2019

(30) Foreign Application Priority Data
Sep. 26, 2016 (DE) 10 2016 118 149.8

(51) Int. Cl. H01F 27/06; H01F 27/28; H01F 27/24

(52) U.S. Cl. CPC H01F 27/06; B61C 3/00; H01F 27/24; H01F 27/28

(57) ABSTRACT

A transformer includes: two coils, each coil having a core and a plurality of windings; and a support device in which the coils are held, the support device having feet for setting up the support device on a base. Longitudinal axes of the coils can be oriented horizontally by setting up the support device on the base.

### CROSS-REFERENCE TO PRIOR APPLICATIONS

This application is a U.S. National Phase application under 35 U.S.C. § 371 of International Application No. PCT/EP2017/074375, filed on Sep. 26, 2017, and claims benefit to German Patent Application No. DE 10 2016 118 149.8, filed on Sep. 26, 2016. The International Application was published in German on Mar. 29, 2018 as WO 2018/055202 under PCT Article 21(2).

### FIELD

The invention relates to a transformer comprising two coils, wherein each coil has a core and a plurality of windings, and wherein the coils are held in a support device.

### BACKGROUND

Transformers or their coils are frequently set up in such a way that their longitudinal axes are oriented vertically. This results in a relatively high overall height. Furthermore, transformers are usually not designed such that they can withstand strong vibrations without damage.

In certain applications, there is however a need to arrange a transformer in an engine room, in particular of a rail vehicle. In an engine room, only a specific area is often times available for setting up a transformer. Furthermore, a transformer in an engine room of a vehicle is exposed to significant vibrations in certain circumstances.

### SUMMARY

In an embodiment, the present invention provides a transformer, comprising: two coils, each coil having a core and a plurality of windings; and a support device in which the coils are held, the support device having feet configured to set up the support device on a base, wherein longitudinal axes of the coils are configured to be oriented horizontally by setting up the support device on the base.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a transformer in which the longitudinal axes of the coils are oriented horizontally relatively to a base, and

FIG. 2 is a view of the support device, in which the coils according to FIG. 1 are mounted one above the other.

### DETAILED DESCRIPTION

In an embodiment, the present invention provides a transformer that has as long as service life as possible with a low and compact design in a vehicle.

Accordingly, the aforementioned transformer is characterized in that the support device has feet for setting up the support device on a base, wherein the longitudinal axes of the coils can be oriented horizontally by setting up the support device on the base.

According to the invention, it was initially realized that it is necessary to change existing transformers so that they can be used in a machine room of vehicles, in particular rail vehicles. It was then realized that, in particular, electrical clearances must be maintained in a narrow installation space, and the transformer must withstand high mechanical loads. Coils can be arranged horizontally relatively to a base by means of a suitable support device. A certain overall installation height is not exceeded thereby, even if the coils are relatively long. Furthermore, the coils are supported against vibrations in the support device.

The feet advantageously have a fixing device for fixing the support device on the base. The fixing device can be designed as passages for screws. This allows the transformer to be connected to a vehicle in a positionally secure and immovable manner.

Particularly preferably, the support device has two feet that are spaced from each other, wherein a pressing bar projects from each foot, and wherein the coils extend between the pressing bars. As a result, the coils can be stacked one above the other in the support device so that their longitudinal axes are oriented parallelly. The coils can be fixed to the pressing bars and supported against vibrations.

More advantageously, a pressing bar is provided with at least one strut and/or reinforcement for bracing. This allows large forces in or transverse to the travel direction of the vehicle to be compensated without noticeably bending the pressing bars. Bending or compression of the pressing bars is also avoided. Furthermore, shifting of the coils is avoided.

In order to control large forces in the travel direction, transverse to the travel direction and in the vertical direction, the connections to the base, in particular a car floor, need to be specially designed.

Advantageously, the feet are connected to each other by an intermediate strut. This as well makes it possible to compensate for large forces in or transverse to the direction of travel of the vehicle without the pressing bars bending noticeably. In addition, slipping of the coils is advantageously avoided.

The intermediate strut advantageously extends parallelly to the longitudinal axes of the coils. This prevents the support device from being compressed in the direction of the longitudinal axis of the coils.

The windings of a single coil are advantageously connected to one another and/or to the core of the respective coil in order to avoid bending or slipping. The connection may be made by an adhesive.

The windings are advantageously arranged horizontally and one above the other. This prevents the windings from slipping.

The coils are advantageously connected to one another. The position of the coils relative to each other is thus retained, even under severe vibrations. The coils are preferably adhered to one another.

An arrangement preferably comprises a transformer of the type described herein and a vehicle, which has a support, wherein the coils are oriented horizontally relatively to the base or a plane of travel.

The transformer described here is preferably used in rail vehicles, namely in railway operation. In railway operation, particularly strong vibrations occur so that the transformer described herein is particularly suitable for this use.

The support device can advantageously be connected to a car body of a rail vehicle. In spite of given dimensions, vibrations and masses, a high degree of efficiency can thus be ensured, and material fatigue can be counteracted.

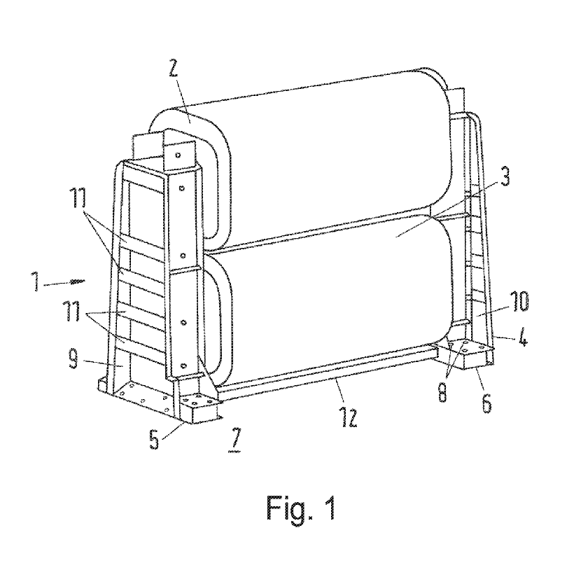

FIG. 1 shows a transformer 1 comprising two coils 2, 3, wherein each coil 2, 3 has a core and a plurality of windings, and wherein the coils 2, 3 are held in a support device 4.

The support device 4 has feet 5, 6 for setting up the support device 4 on a base 7, wherein the longitudinal axes of the coils 2, 3 can be oriented horizontally by setting up the support device 4 on the base 7. In a specific case, the longitudinal axes are arranged parallelly to one another and horizontally.

The feet 5, 6 have a fixing device 8, namely passages, for fixing the support device 4 on the base 7. Screws can be guided through the passages in order to screw the support device 4 to the base 7.

The support device 4 has two feet 5, 6 that are spaced from each other, wherein a pressing bar 9, 10 projects from each foot 5, 6 and wherein the coils 2, 3 extend between the pressing bars 9, 10.

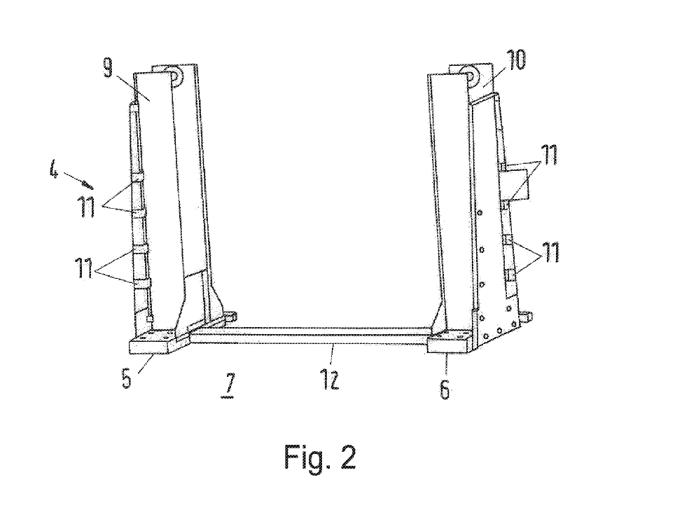

FIG. 2 shows that a pressing bar 9, 10 is provided with struts 11 and/or reinforcements for bracing.

FIG. 2 further shows that the feet 5, 6 are connected to each other by an intermediate strut 12.

The intermediate strut 12 extends parallelly to the longitudinal axes of the coils 2, 3.

The windings of a single coil 2, 3 are connected to one another and/or to the core in order to avoid bending or slipping. The windings are arranged horizontally and one above the other.

The coils 2, 3 are also connected to each other.

The transformer 1 known from FIG. 1 can advantageously be arranged on a vehicle which has a base 7, wherein the coils 2, 3 are oriented horizontally with respect to the base 7 or a plane of travel. The vehicle can be designed as a rail vehicle.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 Transformer
2 Coil
3 Coil
4 Support device
5 Foot
6 Foot
7 Base
8 Fixing device
9 Pressing bar
10 Pressing bar
11 Strut
12 Intermediate strut

1. A transformer, comprising:
two coils, each coil having a core and a plurality of windings; and
a support device in which the coils are held,
the support device having feet configured to set up the support device on a base,
wherein longitudinal axes of the coils are configured to be oriented horizontally by setting up the support device on the base.

2. The transformer according to claim 1, wherein the feet comprise a fixing device configured to fix the support device on the base.

3. The transformer according to claim 1, wherein the support device has two feet that are spaced from each other,
wherein a pressing bar projects from each foot, and
wherein the coils extend between the pressing bars.

4. The transformer according to claim 3, wherein each pressing bar comprises at least one strut and/or reinforcement for bracing.

5. The transformer according to claim 1, wherein the feet are connected to each other by an intermediate strut.

6. The transformer according to claim 5, wherein the intermediate strut extends parallel to the longitudinal axes of the coils.

7. The transformer according to claim 1, wherein the windings of a single coil are connected to one another and/or to the core so as to avoid bending or slipping.

8. The transformer according to claim 1, wherein the windings are arranged horizontally and one above the other.

9. The transformer according to claim 1, wherein the coils are connected to each other.

10. An arrangement, comprising:
the transformer according to claim 1; and
a vehicle having the base,
wherein the coils are oriented horizontally relatively to the base or a plane of travel.
